(19) United States
(12) Patent Application Publication
(10) Pub. No.: US 2012/0026286 A1
(43) Pub. Date: Feb. 2, 2012

(54) Electronic Apparatus and Image Processing Method

(76) Inventor: Mushan Wang, Akishima-shi (JP)

(21) Appl. No.: 13/028,943

(22) Filed: Feb. 16, 2011

(30) Foreign Application Priority Data
Jul. 27, 2010 (JP) 2010-168553

(51) Int. Cl. H04N 13/00

(52) U.S. Cl. 348/43; 348/E13.06

(57) ABSTRACT

According to one embodiment, there is provided an electronic apparatus, including: a movie-noise reduction processor configured to successively perform a movie-noise reduction process on an input luminance signal to thereby generate an output luminance signal, the output luminance signal being generated based on the input luminance signal and another output luminance signal having been generated; a frame memory configured to store the output luminance signals; and a signal entry module configured to determine whether or not the input luminance signal is of a 3D video, to select one of the output luminance signals stored in the frame memory such that a frame associated with a selected one of the output luminance signals has no parallax with a frame associated with the input luminance signal, and to enter the selected one of the output luminance signals into the movie-noise reduction processor as the another output luminance signal.

### CROSS-REFERENCE TO RELATED APPLICATION(S)

This application is based upon and claims the benefit of priority from Japanese Patent Application No. 2010-168553, filed on Jul. 27, 2010, the entire contents of which are incorporated herein by reference.

### FIELD

Embodiments described herein relate generally to an electronic apparatus and an image processing method.

### BACKGROUND

Owing to technological progress in recent years, electronic apparatuses capable of displaying 3D videos for users have been proposed. There are two example methods for realizing the 3D videos. A first example is a frame-sequential scheme, in which an image for the left eye and an image for the right eye are alternately displayed for the user wearing shutter glasses configured to show the image for the left eye to only the left eye and show the image for the right eye to only the right eye, respectively.

A second example is a scheme, in which pixels for the left eye and pixels for the right eye as exist within one frame are displayed for the user of naked eyes while using a panel configured to show only the pixels for the left eye to the left eye and show only the pixels for the right eye to the right eye, simultaneously.

For example, when displaying the 3D video by the above schemes, the electronic apparatus may be required to perform processes different from those in the case of displaying general 2D video.

For example, when performing an image processing on pixels in a frame with reference to pixels in preceding and succeeding frames, an electronic apparatus may be required to perform different processes for a 2D video and for a 3D video. In other words, the 3D video could not be treated only by image processing modules for the 2D video.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates a video output system in an embodiment.

FIG. 2 illustrates system configurations of a DTV and shutter glasses in the embodiment.

FIG. 3 illustrates a functional block configuration of a video process portion in the embodiment.

FIG. 4 illustrates a functional block configuration of a movie-noise reduction process portion in the embodiment.

FIG. 5 schematically illustrates the sequence of frame-sequential frames which are delivered alternately for the right eye and the left eye.

FIG. 6 illustrates a movie-noise reduction process in the embodiment.

### DETAILED DESCRIPTION

In general, according to one embodiment, there is provided an electronic apparatus, including: a movie-noise reduction processor configured to successively perform a movie-noise reduction process on an input luminance signal to thereby generate an output luminance signal, the output luminance signal being generated based on the input luminance signal and another output luminance signal having been generated; a frame memory configured to store the output luminance signals; and a signal entry module configured to determine whether or not the input luminance signal is of a 3D video, to select one of the output luminance signals stored in the frame memory such that a frame associated with a selected one of the output luminance signals has no parallax with a frame associated with the input luminance signal, and to enter the selected one of the output luminance signals into the movie-noise reduction processor as the another output luminance signal.

Embodiments will be described with reference to the drawings below.

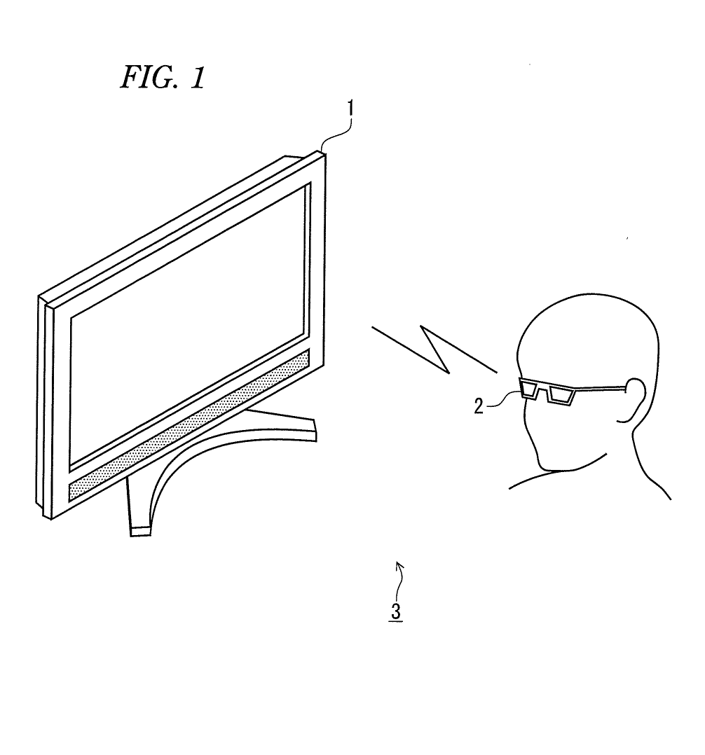

FIG. 1 illustrates a video output system 3 in an embodiment. A DTV 1, shutter glasses 2 and the video output system 3 are shown in FIG. 1.

In this embodiment, the DTV 1 such as a digital television is exemplified as an electronic apparatus. The DTV 1 is capable of displaying a 3D video to a user who wears the shutter glasses 2, by alternately displaying an image for the left eye (left-eye image) and an image for the right eye (right-eye image) as have a parallax therebetween (frame-sequential scheme). While the DTV 1 is exemplified as the electronic apparatus in this embodiment, any of various apparatuses such as a DVD (Digital Versatile Disk) player, an HDD (Hard Disk Drive) player, an STB (Set Top Box) and a PC (Personal Computer) can be used as the electronic apparatus.

The shutter glasses 2 have shieldable (closable) liquid-crystal shutters for a lens for the left eye and a lens for the right eye, respectively, and the lenses and the shutters may be called the “lens units” in combination. The shutter glasses 2 realize the 3D video for the user by opening/closing the respective shutters of the left and right lens units at different timings based on shutter opening/closing signals which are received from the DTV 1. For example, when the left-eye image is displayed on the DTV 1, the shutter of the lens unit for the right eye is closed (brought into a shield state) and the shutter of the lens unit for the left eye is opened (brought into a transmission state), based on the opening/closing signals from the DTV 1, thereby to show the left-eye image to only the left eye of the user. Besides, when the right-eye image is displayed, the shutter of the lens unit for the left eye is closed and the shutter of the lens unit for the right eye is opened, thereby to show the right-eye image to only the right eye of the user. Owing to these operations, the user perceives the video as a 3D video.

The principle for realizing the above 3D video will be described. A human usually looks at an object by the left eye and the right eye of different positions, respectively, and a parallax exists between images watched by the left eye and the right eye. The human can recognize the object looked at, as a 3D object in such a way that the image watched by the left eye and the image watched by the right eye as have the parallax are synthesized in brains. Therefore, the left-eye image and the right-eye image as have the parallax are shown to the respective eyes, whereby a user perceives a video as the 3D video. Using this principle, the shutter glasses 2 realize the 3D video for the user based on the video of the DTV 1.

The video output system 3 has the DTV 1 and the shutter glasses 2. The user wears the shutter glasses 2 and watches the video displayed on the DTV 1, whereby he/she can recognize this video as the 3D video.

Next, the internal structures of the DTV 1 and the shutter glasses 2 will be described in detail.

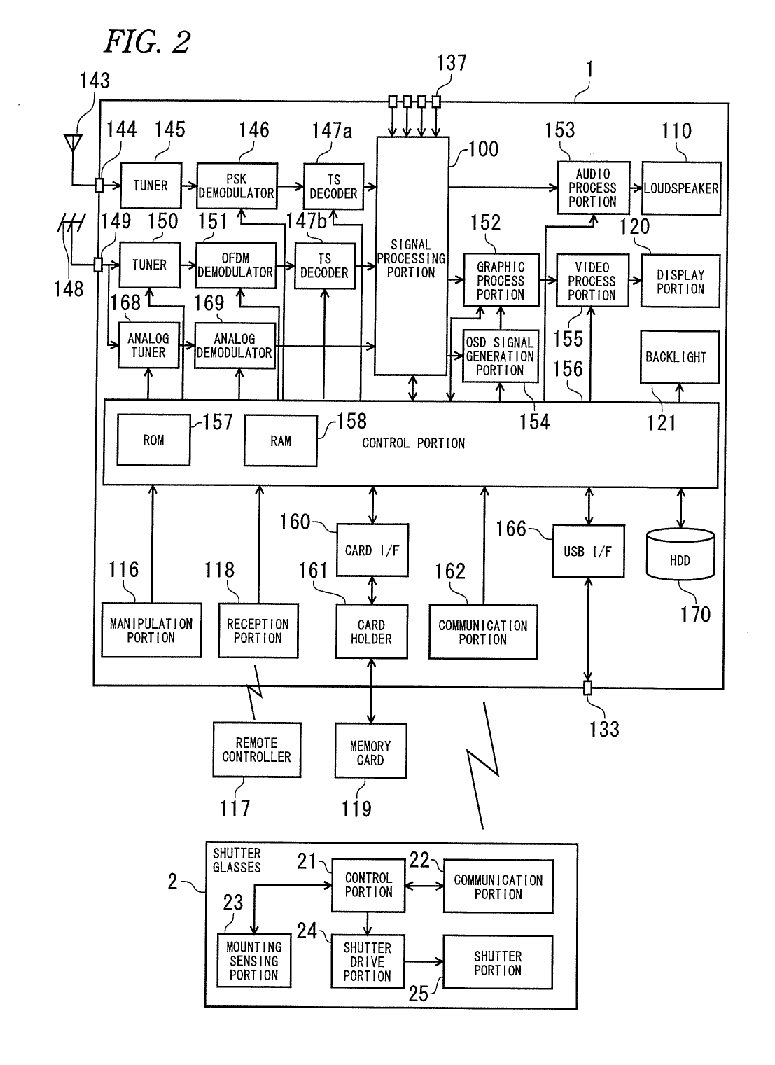

FIG. 2 illustrates system configurations of the DTV 1 and the shutter glasses 2 in this embodiment.

First, the internal structure of the DTV 1 will be described.

The DTV 1 includes a control portion 156 which controls the operations of the various portions of the apparatus. A CPU (Central Processing Unit), etc. are built in the control portion 156. This control portion 156 activates a system control program and various process programs which are stored in a ROM (Read Only Memory) 157 beforehand, in response to a manipulation signal which is inputted from a manipulation portion 116, or a manipulation signal which is transmitted from a remote controller 117 and received through a reception portion 118. In accordance with the activated programs, the control portion 156 controls the operations of the various portions of the apparatus by employing the RAM (Random Access Memory) 158 as a work memory.

An input terminal 144 feeds a tuner 145 for a digital satellite broadcasting, with a digital satellite television broadcasting signal which has been received by an antenna 143 for receiving digital BS/CS broadcastings. The tuner 145 tunes the received digital broadcasting signal, and transmits the tuned digital broadcasting signal to a PSK (Phase Shift Keying) demodulator 146. The PSK demodulator 146 demodulates a TS (Transport Stream), and feeds the demodulated TS to a TS decoder 147a. The TS decoder 147a decodes the TS into a digital signal which contains a digital video signal, a digital audio signal and a data signal, and it thereafter delivers this digital signal to a signal processing portion 100. The “digital video signal” here is a digital signal concerning a video which the DTV 1 can deliver, and the “audio signal” is a digital signal concerning a voice which the DTV 1 can deliver. Besides, the “data signal” is a digital signal concerning information on the broadcasting program of a broadcasting wave as includes, for example, program-related information being information which the DTV 1 uses when an EPG (Electronic Program Guide) being an electronic program table is generated. The program-related information contains such information items as the title of the broadcasting program, the detailed information of the program, and a program start time and a program end time.

An input terminal 149 feeds a tuner 150 for a digital terrestrial broadcasting, with a digital terrestrial television broadcasting signal which has been received by an antenna 148 for receiving the digital terrestrial broadcasting. The tuner 150 tunes the received digital broadcasting signal, and transmits the tuned digital broadcasting signal to a corresponding OFDM (Orthogonal Frequency Division Multiplexing) demodulator 151. The OFDM demodulator 151 demodulates a TS, and feeds the demodulated TS to a corresponding TS decoder 147b. The TS decoder 147b decodes the TS into digital video and audio signals, etc., and it thereafter delivers these signals to the signal processing portion 100.

The antenna 148 is capable of receiving also analog terrestrial broadcasting signals. The received analog terrestrial broadcasting signals are distributed by a distributor, not shown, and are fed to an analog tuner 168. The analog tuner 168 tunes the received analog broadcasting signals, and transmits the tuned analog broadcasting signal to an analog demodulator 169. The analog demodulator 169 demodulates the analog broadcasting signal, and delivers the demodulated analog broadcasting signal to the signal processing portion 100. Besides, with the DTV 1, for example, also a CATV (Common Antenna Television) can be viewed by connecting a tuner for the CATV to the input terminal 149 to which the antenna 148 is connected.

The signal processing portion 100 executes appropriate signal processing for a digital signal delivered from the TS decoder 147a or 147b or the control portion 156. More concretely, the signal processing portion 100 separates the digital signal into a video signal, a digital audio signal and a data signal. The separated video signal is delivered to a graphic process portion 152, and the separated audio signal to an audio process portion 153. Besides, the signal processing portion 100 converts the broadcasting signal delivered from the analog demodulator 169, into a video signal and an audio signal of predetermined digital format. The digital converted video signal is delivered to the graphic process portion 152, and the digital audio signal to the audio process portion 153. Besides, the signal processing portion 100 executes predetermined digital signal processing, also for input signals from line input terminals 137.

An OSD (On Screen Display) signal generation portion 154 generates an OSD signal for displaying a UI (User Interface) screen or the like, in accordance with the control of the control portion 156. Besides, the data signal separated from the digital broadcasting signal in the signal processing portion 100 is converted into an OSD signal of appropriate format by the OSD signal generation portion 154, and the OSD signal is delivered to the graphic process portion 152.

The graphic process portion 152 executes the decode process of the digital video signal delivered from the signal processing portion 100. The decoded video signal is superposed on and composed with the OSD signal delivered from the OSD signal generation portion 154, and the resulting signal is delivered to a video process portion 155. The graphic process portion 152 can also deliver the selected one of the decoded video signal and the OSD signal to the video process portion 155.

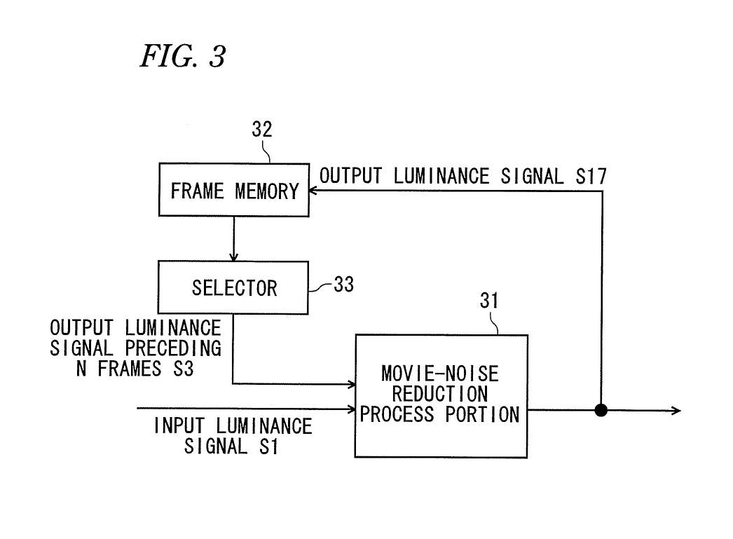

The video process portion 155 makes the correction of an image quality for the signal delivered from the graphic process portion 152, and then converts the resulting signal into an analog video signal in a format displayable by a display portion 120. The analog converted video signal from the video process portion 155 is displayed on the display portion 120. The correction of the image quality in the video process portion 155 will be detailed in description taken with reference to FIG. 3, et seq.

The display portion 120 has an LCD (Liquid Crystal Display) for displaying an image. A backlight 121 illuminates the display portion 120 from the rear. Besides, the backlight 121 is capable of adjusting the luminance of the video to be displayed, in accordance with the intensity of illuminating light or an illumination time period.

The audio process portion 153 converts the entered audio signal into an analog audio signal in a format reproducible by a loudspeaker 110. The analog converted audio signal is delivered to and reproduced by the loudspeaker 110.

A card holder 161 is connected to the control portion 156 through a card I/F (Interface) 160. A memory card 119 is mountable in the card I/F 160. The memory card 119 is a storage medium, for example, an SD (Secure Digital) memory card, an MMC (Multimedia Card) or a CF (Compact Flash) card. The memory card 119 mounted in the card holder 161, and the control portion 156 can write/read information through the card I/F 160.

A USB (Universal Serial Bus) terminal 133 is connected to the control portion 156 through a USB I/F 166. The USB terminal 133 is used as a general USB-adapted port. A portable telephone, a digital camera, card readers/writers for various memory cards, an HDD, a keyboard, etc. are connected to the USB terminal 133 through, for example, a hub. The control portion 156 can communicate (transmit and receive) information between it and the apparatus which is connected through the USB terminal 133.

An HDD 170 is a magnetic storage medium which is built in the DTV 1, and stores various information items.

A signal transmission portion 162 is, for example, an infrared signal transmission module, and it can transmit the opening/closing signals to the shutter glasses 2 in terms of infrared signals. The control portion 156 senses the display states of the right-eye image and the left-eye image in the 3D video, and transmits the shutter opening/closing signals to the shutter glasses 2 by the signal transmission portion 162 based on the display states of the 3D video. The control portion 156 transmits the opening/closing signals by the signal transmission portion 162 so as to open the shutter for the right eye in the shutter glasses 2 (to bring this shutter into the transmission state) and to close the shutter for the left eye (to bring this shutter into the shield state) when the display portion 120 is displaying the right-eye image, and to close the shutter for the right eye (to bring this shutter into the shield state) and to open the shutter for left eye (to bring this shutter into the transmission state) when the display portion 120 is displaying the left-eye image.

Next, the internal structure of the shutter glasses 2 will be described.

A control portion 21 performs the control of the whole shutter glasses 2, and has a built-in MPU (Micro Processing Unit). The control portion 21 is capable of transmitting and receiving signals to and from individual modules connected thereto.

A signal reception portion 22 is, for example, an infrared reception module, and receives the opening/closing signals transmitted by the signal transmission portion 162. In this embodiment, the signal transmission portion 162 and the signal reception portion 22 are the infrared communication modules, and the DTV 1 and the shutter glasses 2 are exemplified as transmitting and receiving the opening/closing signals in terms of infrared radiations. However, this example is not restrictive, but the signal transmission portion 162 and the signal reception portion 22 can be configured of communication modules which conform to various communication standards irrespective of wired or radio schemes.

A shutter drive portion 24 is a liquid-crystal drive device which drives a shutter portion 25 made of a liquid crystal. The shutter drive portion 24 drives the respective left and right liquid-crystal shutters of the shutter portion 25 based on the opening/closing signals from the DTV 1 as are received by the signal reception portion 22.

The shutter portion 25 is disposed for the lens units of the shutter glasses 2, and it is driven by the shutter drive portion 24 so as to switch the shield and transmission in the respective lens units for the right eye and for the left eye.

When the signal reception portion 22 of the shutter glasses 2 receive the opening/closing signals, the control portion 21 instructs the shutter drive portion 24 to drive the shutter portion 25 based on the signals. The shutter drive portion 24 switches the shield and transmission of the shutter portion 25 based on the instructions.

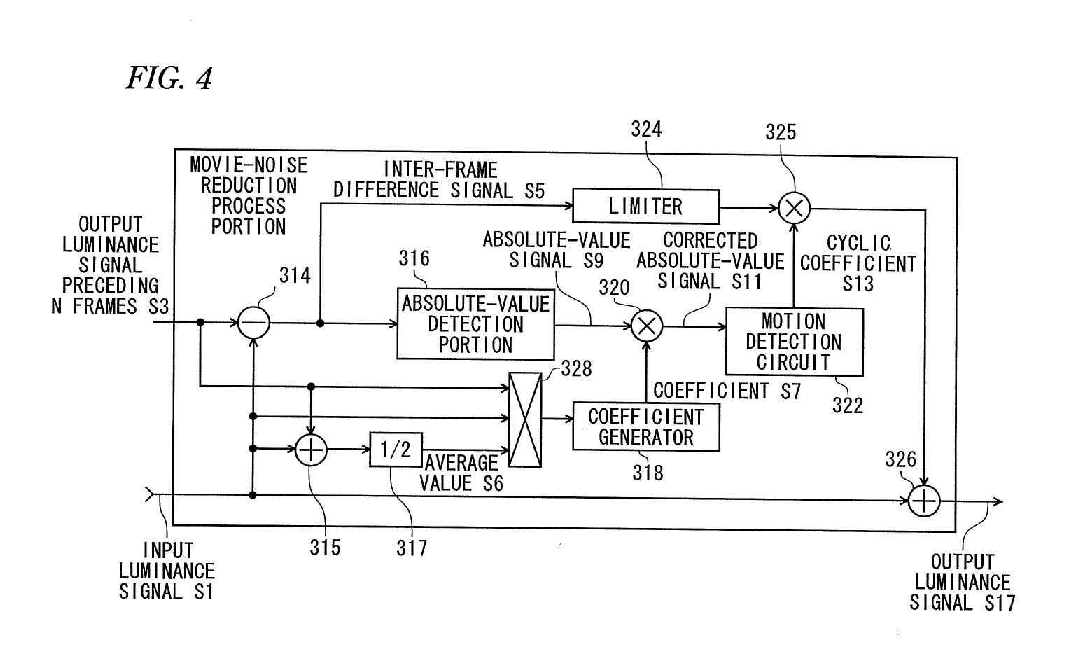

Next, part of a configuration in the video process portion 155 will be described with reference to FIGS. 3 and 4.

FIG. 3 illustrates a functional block configuration of the video process portion 155 in an embodiment.

In this embodiment, the video process portion 155 subjects a luminance signal in the entered video signal, to a movie-noise reduction process as image processing. The video process portion 155 includes a movie-noise reduction process portion 31, a frame memory 32 and a selector 33.

The movie-noise reduction process portion 31 subjects an input luminance signal S1 entered from the process portion of the preceding stage, to the noise reduction process of a movie, and then delivering the processed signal as an output luminance signal S17. When the movie-noise reduction process portion 31 executes the noise reduction process for the input luminance signal S1, it refers to an image preceding N frames (predetermined number of frames). The detailed configuration of the movie-noise reduction process portion 31 will be described in detail later with reference to FIG. 4.

The movie-noise reduction process portion 31 delivers the output luminance signal S17 being the luminance signal subjected to the noise reduction process, to the process portion at the succeeding stage of the video process portion 155 and to the frame memory 32. The frame memory 32 holds the entered output luminance signal S17. This frame memory 32 is, for example, a buffer made of a semiconductor, and it is configured within the video process portion 155. In this embodiment, the frame memory 32 is exemplified as being configured within the video process portion 155. However, this is not restrictive, but for example, part of the RAM 158 of the control portion 156 may well be utilized as the frame memory 32.

The selector 33 has the function of selectively delivering the frame stored in the frame memory 32. When the image existing in the movie-noise reduction process portion 31 is entered as the input luminance signal S1, the selector 33 enters the output luminance signal S3 of an image preceding N frames to the input image, into the movie-noise reduction process portion 31 as signal entry module.

In this manner, the movie-noise reduction process portion 31 is fed with the input luminance signal S1 to be subjected to the movie-noise reduction process, and the output luminance signal S3 delivered by itself and preceding the N frames, and it executes the movie-noise reduction process for the input luminance signal S1, based on the output luminance signal S3 preceding the N frames.

The configuration of the movie-noise reduction process portion 31 and the noise reduction process to be executed, will be described below.

FIG. 4 illustrates a functional block configuration of the movie-noise reduction process portion 31 in the embodiment.

The movie-noise reduction process portion 31 includes a subtraction portion 314 and an addition portion 326 which receive the input luminance signal S1.

Besides, the output luminance signal S3 preceding N frames as has been delivered by the frame memory 32 is fed to the subtraction portion 314, and an inter-frame difference signal S5 can be obtained at the output of the subtraction portion 314. At the succeeding stage of the output of the subtraction portion 314, there are disposed a limiter 324 which limits the amplitude of the entered signal S5 to a constant value and then delivers the resulting signal to the succeeding stage thereof, and a multiplication portion 325 which receives the output from the limiter 324.

Further, the movie-noise reduction process portion 31 includes an absolute-value detection portion 316 which receives the inter-frame difference signal S5 from the subtraction portion 314 and which delivers the signal S9 of the absolute value of the received signal S5, and a multiplication portion 320 which receives the inter-frame difference absolute-value signal S9 from the absolute-value detection portion 316. Besides, the movie-noise reduction process portion 31 includes an addition portion 315 which receives the input luminance signal S1 and the output luminance signal S3 preceding the N frames from the frame memory 32 and which delivers the addition result of the received signals, and an averaging portion 317 which delivers the average value of such addition results.

Further, the movie-noise reduction process portion 31 includes a selection portion 328 which receives the three signals of the output luminance signal S3 preceding the N frames, the input luminance signal S1 and the average value signal from the averaging portion 317, and which selects and delivers one of the received signals (or at least two of them, or a plurality of average values, as will be stated later). The selection portion 328 selects signal information corresponding to the image brightness and delivers the signal information to a coefficient generator 318 at a succeeding stage, in order to control the noise reduction process, and it selects and delivers one from among the plurality of signals in accordance with predetermined selection criteria.

Further, the movie-noise reduction process portion 31 includes the coefficient generator 318 which receives the signal corresponding to the image brightness from the selection portion 328, and which generates a coefficient corresponding to the signal and feeds the coefficient to the multiplication portion 320. In this multiplication portion 320, a multiplication process is executed based on the coefficient, so as to deliver a corrected inter-frame difference absolute-value signal S11. The corrected absolute-value signal S11 is received by a motion detection circuit 322. The motion detection circuit 322 detects the motion of the image of a general movie signal from the entered signal, and it generates a cyclic coefficient S13 which relieves the noise reduction process, in correspondence with the detected motion. The cyclic coefficient S13 is fed to the multiplication portion 325.

The movie-noise reduction process portion 31 having such a configuration executes an appropriate noise reduction process in accordance with the image brightness (luminance, etc.) and the degree of the motion of the movie signal, as stated below. The value of the inter-frame difference signal S5 from the subtraction portion 314 is adjusted chiefly by the functions of the multiplication portions 320 and 325, so as to intensify the noise reduction process when the image is dark and to relieve the noise reduction process when the image is bright. Besides, the motion detection circuit 322 and the multiplication portion 325 relieve the residual image of a screen in such a way that the noise reduction process is interrupted when the motion magnitude of the movie signal is a predetermined magnitude or above, or that the noise reduction process is relieved in proportion to the value of the motion magnitude of the movie signal.

Thus, the noise reduction process is stopped or relieved at the bright part of the image, and it is intensified at the dark part of the image, whereby noise is reduced as a whole, and a movie screen of high quality in which the residual image is unobtrusive can be obtained.

In the concrete, the input luminance signal S1 is entered into the subtraction portion 314 together with the output luminance signal S3 preceding N frames as has been read out of the frame memory 32, thereby to obtain the inter-frame difference signal S5. The inter-frame difference signal S5 has its amplitude limited to a certain desired value by the limiter 324, and it is thereafter multiplied by the cyclic coefficient S13 by the multiplication portion 325.

The cyclic coefficient S13 is a coefficient which contains the image brightness and the motion component of the movie. When the image becomes bright, the value of the coefficient S7 of the coefficient generator 318 enlarges, and hence, also the value of the corrected absolute-value signal S11 enlarges. Thus, the value of cyclic coefficient S13 becomes small. Accordingly, the multiplication portion 325 makes small the value of the difference signal S5 having passed through the limiter 324, thereby to suppress (relieve or stop) the degree of the noise removal process in the calculation portion 326.

Further, the input luminance signal S1 is subjected to an addition or a subtraction with the difference signal S5 from the multiplication portion 325, by the calculation portion 326, thereby to remove the noise in the movie signal. The calculation portion 326 executes the process of the subtraction or addition, depending upon the sign (plus or minus) of the difference signal from the multiplication portion 325, so as to remove the noise.

On the other hand, the input luminance signal S1, the output luminance signal S3 preceding the N frames, and the average value signal S6 of the signals S1 and S3 are fed to the selection portion 328, and one of these signals is selected and fed to the coefficient generator 318 by the selection portion 328. In the coefficient generator 318, the coefficient S7 corresponding to the level of the selected signal is delivered, and this coefficient S7 is multiplied by the inter-frame difference absolute-value signal S9, by the multiplication portion 320. The inter-frame difference absolute-value signal S11 thus corrected is entered into the motion detection circuit 322. Here, for example, the coefficient generator 318 generates a value less than one in a case where the input signal level is smaller than a predetermined range, and it generates a value greater than one in a case where the input signal level is larger than the predetermined range. On this occasion, when the input signal level is lower, the corrected absolute-value signal S11 becomes a value smaller than the absolute-value signal S9, and when the input signal level is higher, the corrected absolute-value signal S11 becomes a value larger than the absolute-value signal S9.

The motion detection circuit 322 functions to make the value of the cyclic coefficient S13 smaller as the corrected inter-frame difference absolute-value signal S11 is larger, so as to lower a noise reduction effect and to diminish the residual image. In other words, when the input signal level is low, the cyclic coefficient S13 becomes larger than usual, and when the input signal level is high, the cyclic coefficient S13 becomes smaller than usual. That is, at the dark part where the noise is obtrusive, the noise reduction effect is heightened, and at the bright part where the noise is unobtrusive, the noise reduction effect is lowered to diminish the residual image.

In this manner, the movie-noise reduction process portion 31 considers the fact that, even when the noise of the movie signal is at an identical noise level, the obtrusiveness of the noise differs depending upon the image signal level (the image brightness), and it controls the noise reduction effect in correspondence with the image signal level (the image brightness), whereby the movie signal of high quality can be obtained.

In this example, the corrected inter-frame difference absolute-value signal S11 has been obtained using the coefficient generator 318 and the multiplication portion 320, but the embodiment of the present invention is not restricted to this configuration. For example, the functions of the coefficient generator 318 and the multiplication portion 320 (and further, the functions of the motion detection circuit 322 and the multiplication portion 325) are substituted by a CPU and a lookup table incarnated by a RAM or the like, whereby a noise reduction process corresponding to still subtler image signal levels (the image brightnesses) can be realized.

For example, part of the movie-noise reduction process stated above is explained in JP-2005-347821-A.

In this embodiment, when the movie-noise reduction process portion 31 executes the movie-noise reduction process as to the 2D image (when the input luminance signal S1 is one of the 2D image), the selector 33 delivers the output luminance signal preceding one frame as is stored in the frame memory 32, as the output luminance signal S3 preceding the N frames (N=1 holds in the case of the 2D image). Thus, the movie-noise reduction process portion 31 can execute the movie-noise reduction process based on the directly preceding frame which has no parallax with respect to the frame to be subjected to the movie-noise reduction process.

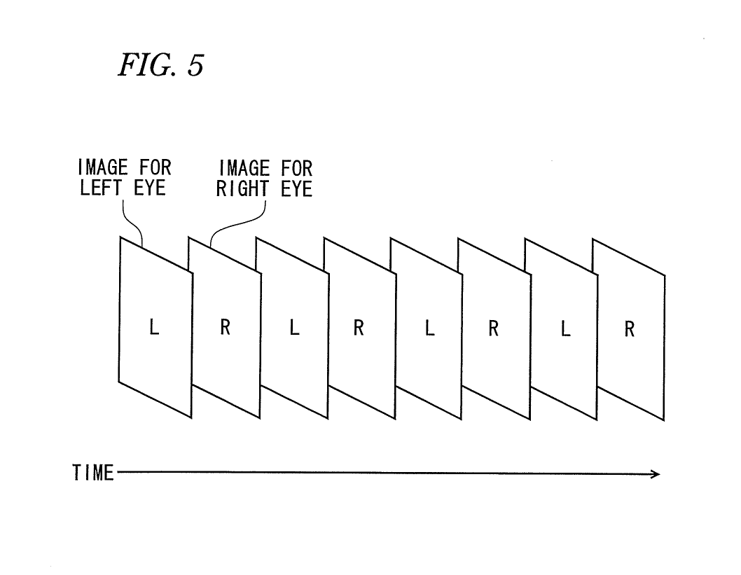

Besides, when the movie-noise reduction process portion 31 executes the movie-noise reduction process as to the 3D video of the frame-sequential scheme in which the left-eye image and the right-eye image are alternately displayed, the selector 33 delivers the output luminance signal preceding two frames as is stored in the frame memory 32, as the output luminance signal S3 preceding the N frames (N=2 holds in this case). The reason therefor is as stated below. In the case of the 2D image, the image preceding one frame becomes the directly preceding image. In the case of the 3D video, however, the image preceding one frame to the left-eye image becomes the right-eye image, and the image preceding one frame to the right-eye image becomes the left-eye image, as shown in FIG. 5, so that the image preceding one frame becomes the image which has a parallax with respect to the image to be subjected to the movie-noise reduction process. When the above movie-noise reduction process is executed based on the image having the parallax, the inter-frame difference signal S5 becomes the signal of the inter-frame difference between the images having the parallax therebetween, and the movie-noise reduction process is not executed appropriately. Therefore, the movie-noise reduction process can be appropriately executed by performing the process based on the output luminance signal of the image preceding the two frames as is the image for the identical eye.

The selector 33 senses a signal which indicates whether the input video is the 2D video or the 3D video, and which is entered into the video process portion 155. Thus, it selects whether the output luminance signal preceding one frame is to be delivered to the movie-noise reduction process portion 31 or the output luminance signal preceding the two frames is to be delivered thereto, and it delivers the selected output luminance signal. That is, when the video to be entered is the 2D video, the output luminance signal preceding one frame is delivered, and when the entered video is the 3D video, the output luminance signal preceding the two frames is delivered. In this embodiment, the case where the left-eye image and the right-eye image are alternately displayed is exemplified as the sequence of the frames of the images of the 3D video. On this occasion, it has been stated above that the output luminance signal preceding the two frames is entered into the movie-noise reduction process portion 31. However, this is not restrictive, but an output luminance signal preceding even-numbered frames such as preceding four frames or preceding six frames may well be entered. Also in this case, a frame which is referred to in the movie-noise reduction process is prevented from becoming a frame which has a parallax with respect to a frame to be subjected to the movie-noise reduction process.

Besides, in a case, for example, where the 3D video to be entered is not configured by alternately arraying the left-eye image and the right-eye image, the movie-noise reduction process portion 31 may well execute the movie-noise reduction process based on directly preceding frames which have no parallax therebetween (N=3, 4 . . . may well hold).

Next, the flow of the movie-noise reduction process in the embodiment will be described.

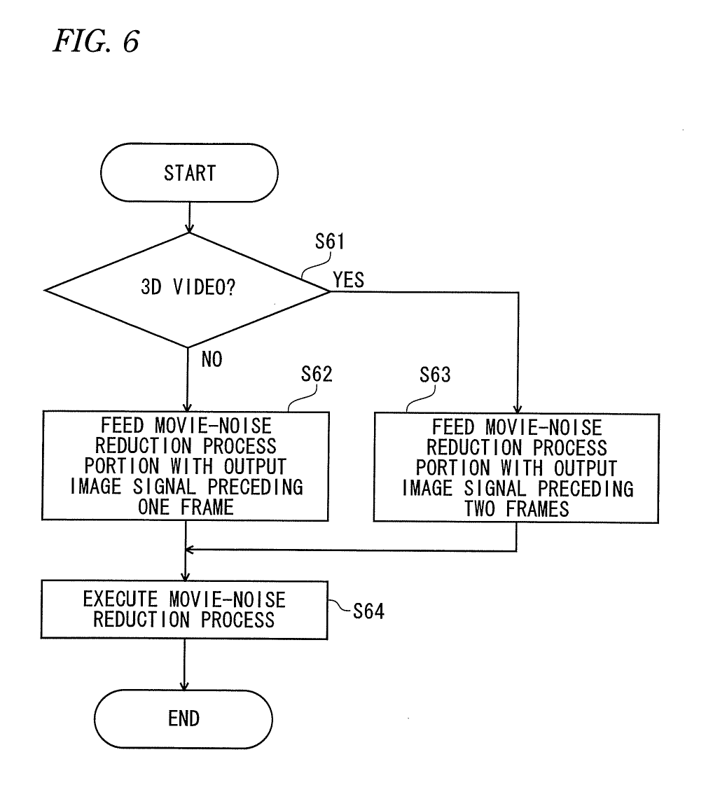

FIG. 6 illustrates the movie-noise reduction process in this embodiment.

First, when the input luminance signal S1 is entered into the movie-noise reduction process portion 31, the selector 33 discriminates whether the video relevant to the input luminance signal S1 is the 2D video or the 3D video (step S61). In this embodiment, it is exemplified that the discrimination of the step S61 is done by sensing the signal which indicates whether the video is the 2D video or the 3D video, and which is entered into the video process portion 155. However, this is not restrictive, but the discrimination of the step S61 may well be done on the basis of, for example, information which indicates whether the video to be entered from the control portion 156 is the 2D video or the 3D video.

As stated before, the selector 33 feeds the movie-noise reduction process portion 31 with the output luminance signal S3 preceding the N frames, among the output luminance signals S17 delivered from the movie-noise reduction process portion 31 and entered into the frame memory 32. When the selector 33 has discriminated at the step S61 that the video to be entered into the video process portion 155 is the 2D video (step S61: No), it feeds the movie-noise reduction process portion 31 with the output luminance signal S3 preceding one frame (step S62).

Besides, when the selector 33 has discriminated at the step S61 that video to be entered into the video process portion 155 is the 3D video (step S61: Yes), it feeds the movie-noise reduction process portion 31 with the output luminance signal S3 preceding the two frames (step S63).

After the step S62 or the step S63, the movie-noise reduction process portion 31 executes the movie-noise reduction process as stated above, based on the input luminance signal S1 and the output luminance signal S3 preceding the N frames (step S64).

The series of processing flow is thus ended. Owing to the processing, the movie-noise reduction process portion is prevented from executing, for example, a process in which the right-eye image is referred to in the movie-noise reduction process of the left-eye image, and the movie-noise reduction process can be appropriately executed for the 3D video.

Besides, in this embodiment, the selector 33 discriminates whether the video to be subjected to the movie-noise reduction process is the 2D video or the 3D video, and the movie-noise reduction process can be appropriately executed in both the cases of the 2D video and the 3D video.

In the above, the movie-noise reduction process for the 3D video based on the frame-sequential scheme has been exemplified and described. However, this is not restrictive, but a movie-noise reduction process can be executed also for a 3D video based on, for example, a naked-eye scheme.

Also in this case, an input luminance signal which is entered into the movie-noise reduction process portion 31 and which is to be subjected to the movie-noise reduction process is divided into a frame in which pixels for the left eye are collected, and a frame in which pixels for the right eye are collected. In the same manner as stated above, the selector 33 enters an image preceding two frames, into the movie-noise reduction process portion 31 as a luminance signal S3 preceding N frames, and the movie-noise reduction process portion 31 executes the movie-noise reduction process with reference to the entered luminance signal. A process portion at a stage further succeeding to the video process portion 155 merges the frame in which the pixels for the left eye as are delivered from the movie-noise reduction process portion 31 are collected, and the frame in which the pixels for the right eye are collected, into one frame, and it delivers the frame in a state where this frame is deliverable as the 3D video.

Besides, in the naked-eye scheme, there is a multi-parallax 3D display which displays videos having still more parallaxes. In a case where, in displaying the 3D video by the naked-eye scheme, pixels having a parallax exist in only one set, the viewable physical range of a user becomes narrow. In the multi-parallax 3D display in the naked-eye scheme, therefore, the viewable physical range of the user is made wider by the display of the videos having a plurality of sets of pixels between/among which parallaxes suitable for grasping the pixels as the 3D video by both the eyes exist.

In this case, the plurality of sets exist as the sets of the pixels for the left eye and for the right eye, to be simultaneously displayed. Therefore, the frames which are merged after having been delivered from the movie-noise reduction process portion 31 do not become only two frames, but a plurality of delivered frames are merged. In a case, for example, where two sets of pixels between which the parallax suitable for grasping the pixels as the 3D video by both the eyes exists are existent in an image which is displayed on the display portion 120, the input luminance signals S1 are entered into the movie-noise reduction process portion 31 in the sequence of a frame in which the pixels for the left eye, in the first set are collected, a frame in which the pixels for the right eye, in the first set are collected, a frame in which the pixels for the left eye, in the second set are collected, and a frame in which the pixels for the right eye, in the second set are collected.

The movie-noise reduction process portion 31 subjects the entered input luminance signal S1 to the movie-noise reduction process every frame and then delivers the resulting signal. Therefore, in a case, for example, where the frame in which the pixels for the left eye, in the second set are collected is subjected to the movie-noise reduction process, and where the output luminance signal preceding two frames is referred to, the movie-noise reduction process is executed by referring to the frame in which the pixels for the left eye, in the first set are collected. In this case, the movie-noise reduction process is executed by referring to the frame which has the parallax with respect to the frame to be subjected to the process, and an appropriate movie-noise reduction process is not executed.

In this embodiment, therefore, the selector 33 switches the frames to which the movie-noise reduction process portion 31 is caused to refer (switches N), in accordance with the number of sets of the pixels between/among which the parallax suitable for grasping the pixels as the 3D video by both the eyes exists.

In a case where the number of sets of the pixels between which the parallax suitable for grasping the pixels as the 3D video by both the eyes exists as stated above is two, the left and right selector 33 delivers a luminance signal preceding four frames, as the output luminance signal S3 preceding the N frames. Thus, the movie-noise reduction process portion 31 can appropriately execute the movie-noise reduction process based on the frame which has no parallax with respect to the frame to be subjected to the process. Besides, in a case where the number of sets is three, the left and right selector 33 delivers a luminance signal preceding six frames, as the output luminance signal S3 preceding the N frames.

In this manner, in the multi-parallax naked-eye 3D display, the video process portion 155 executes the movie-noise reduction process with reference to the frame which precedes to the frame to be subjected to the movie-noise reduction process, double the number of sets of the pixels having the appropriate parallax for grasping the pixels as the 3D video by both the eyes. In other words, the video process portion 155 executes the movie-noise reduction process with reference to the frame which has no parallax with respect to the frame to be subjected to the process.

Owing to the above processing, the DTV 1 can appropriately execute the movie-noise reduction process, also for the 3D video of the naked-eye scheme.

Although the movie-noise reduction process has been exemplified and described in the embodiments, this is not restrictive, but the embodiments are also applicable to cases where various image processes are executed with reference to images preceding several frames.

The present invention is not restricted to the above embodiments, but it can be embodied by modifying constituents within a scope of the invention. For example, several constituents may be omitted from all the constituents in each embodiment, and the constituents of the different embodiments may be properly combined.

What is claimed is:

1. An electronic apparatus, comprising:
a movie-noise reduction processor configured to successively perform a movie-noise reduction process on an input luminance signal to thereby generate an output luminance signal, the output luminance signal being generated based on the input luminance signal and another output luminance signal having been generated;
a frame memory configured to store the output luminance signals; and
a signal entry module configured
to determine whether or not the input luminance signal is of a 3D video,
to select one of the output luminance signals stored in the frame memory such that a frame associated with a selected one of the output luminance signals has no parallax with a frame associated with the input luminance signal, and
to enter the selected one of the output luminance signals into the movie-noise reduction processor as the another output luminance signal.

2. The apparatus of claim 1,
Wherein, when the input luminance signal is determined to be of a 2D video, the signal entry module selects one of the output luminance signals of a frame which is prior to the frame associated with the input luminance signal by one frame.

3. The apparatus of claim 1,
Wherein, when the input luminance signal is determined to be of the 3D video in a frame-sequential scheme in which images for a left eye and images for a right eye are alternately arranged, the signal entry module selects one of the output luminance signals of a frame which is prior to the frame associated with the input luminance signal by two frames.

4. The apparatus of claim 1,
Wherein, when the input luminance signal is determined to be of the 3D video in a multi-parallax scheme, the signal entry module selects one of the output luminance signals of a frame which is prior to the frame associated with the input luminance signal by the number of frames, the number being double the number of sets of pixels for a left eye and a the right eye contained in the 3D video in the multi-parallax scheme.

5. The apparatus of claim 1, further comprising:
a discrimination module configured to discriminate whether the input luminance signal to be entered into the movie-noise reduction processor is of the 3D video or a 2D video;
wherein the signal entry module selects one of the output luminance signals to be entered into the movie-noise reduction processor based on a discrimination.

6. The apparatus of claim 1, further comprising:
a display unit configured to display a video based on the output luminance signal generated by the movie-noise reduction processor.

7. The apparatus of claim 1, further comprising:
a tuner configured to receive a broadcast wave containing a video, the video including the input luminance signal to be entered into the movie-noise reduction processor.

8. An image processing method, comprising:
successively performing, by a movie-noise reduction processor, a movie-noise reduction process on an input luminance signal to thereby generate an output luminance signal, the output luminance signal being generated based on the input luminance signal and another output luminance signal having been generated;
storing, by a frame memory, the output luminance signals;
determining whether or not the input luminance signal is of a 3D video;
selecting one of the output luminance signals stored in the frame memory such that a frame associated with a selected one of the output luminance signals has no parallax with a frame associated with the input luminance signal; and
entering the selected one of the output luminance signals into the movie-noise reduction processor as the another output luminance signal.
